(19) United States
(12) Patent Application Publication
(10) Pub. No.: US 2015/0376915 A1
(43) Pub. Date: Dec. 31, 2015

(54) PRY-PROOF APPARATUS OF COMBINATION LOCK

(71) Applicant: Yao-Kun Yang, CHANGHUA COUNTY (TW)

(72) Inventor: Yao-Kun Yang, CHANGHUA COUNTY (TW)

(21) Appl. No.: 14/315,333

(22) Filed: Jun. 26, 2014

(51) Int. Cl. E05B 37/02

(52) U.S. Cl. CPC E05B 37/02

(57) ABSTRACT

The invention relates to a pry-proof apparatus of combination locks, including a lock case, a lock bottom, a housing seat, a movable member, plural number discs, plural shaft members, and a fastening device which base on the structure of the shaft member. Once a pry inserts a tapering plate probing tool into the aperture again, the probing tool can only be descended to the outer peripheral portion of the shaft member, where the probing tool pries for nothing.

### BACKGROUND OF THE INVENTION

1. Field of the Invention

This invention relates generally to combination locks and more specifically to one that features pry-proof.

2. Description of Related Art

Lock systems are common appliances for burglarproof of which categories are quite wide, for example, a lock may comprise: a lock body, a lock core, a hook and a lock tongue, where the lock core is placed from one end of the lock body while the hook is located at the other end of the lock body, and one end of the hook connects movably with the lock body. The lock tongue joins the lock core in the lock body, and the other end of the hook is inserted into the lock body to buckle with the body tongue so that the user can open the lock by inserting a key into the lock core and rotating, followed by pushing or pulling the lock tongue away from the hook. One end of the hook can then pops out from the lock body to become an unlocking state. With advancement in technology, combination locks later come to market as the device of locking means.

However, the main structure of conventional combination locks includes at least a box, a hook, a movable rod and plural number discs, and its structural function can be accomplished by mutual buckling and interrelating among them. To facilitate the description of the conventional combination locks, a cited example of prior art is given here, shown in FIGS. 11 and 12. Once the grip pit 81 of the shaft member 80 and the protruding rib 83 of the movable member 82 are not clamped one with the other, which means that the number discs 84 dialed by the user are not compliant to the password numbers, and the protruding rib 83 is pressed by the outer peripheral portion 85 of the shaft member 80 that enables the movable member 82 to move downwards to resist the resilience of the elastic member 86 so that the top rib 87 of the movable member 82 props against between the two lock tongues 881 of the fastening device 88, which makes the fastening device 88 unable to retract into the fastening slot 89, and the lock case 90 and the lock bottom 92 are still in locking state.

On the other hand, the grip pit 81 of each shaft member 80 and the corresponding protruding rib 83 are aligned one with the other as each number disc 84 is dialed, which means that the number discs 84 dialed by the user are compliant to the password numbers, which enables the movable member 82 moves upwards by the resilience of the resilient member 86 so that the top rib 87 of the movable member 82 escapes from between the two lock tongues 881 of the fastening device 88, which makes the lock tongues 881 of the fastening device 88 to be pushed into the fastening slot 89, and the lock case 90 and the lock bottom 91 are opened to be in unlocking state.

However, such conventional combination lock is available to unlock with the password numeral, but it may possibly be peeked. The principles of the peeking is to use an aluminum can and cut it to a tapering plate probing tool 92 (as shown in FIGS. 13 and 14). As the probing tool 92 is inserted in the slot 93 between a single number disc 84 and the lock case 90, and props against the outer peripheral portion 85 of the shaft member 80, followed by perceiving a fall of the probing tool 92 as the number disc 84 is being rotated. The grip pit 81 of the shaft member 80 is speculated to be the desired target once the fall is detected by the probing tool 92. And the numeral opposite to the grip pit 81 is the right numeral, an integral part of the password number. The procedure is repeated to get the rest numerals of the password number of the other number discs 84. And it comes out that all combination locks are easily to be peeked, which gravely affects the existence value of the combination locks; therefore, it is necessary to develop a combination lock that features pry-proof.

Furthermore, as shown in FIG. 15, during the production of such combination locks, the manufacturers set a second grip pit 811 at the other end of the shaft member 80, for the ease of mounting and alignment among the shaft members 80 and the number discs 84, where the second grip pit 811 of the shaft members 80 could be peeked likewise by the probing tool 92, which features pry-proof somehow.

### SUMMARY OF THE INVENTION

The primary objective of the present invention is to provide a pry-proof apparatus of combination locks, which can improve the drawbacks of being pried of the conventional combination locks.

The pry-proof apparatus of a combination lock of this creation includes a lock case, and a lock bottom that can be pivoted on or fixed to the lock case, where the lock case are provided with plural apertures on it and a lock base fixed firmly to the lock bottom. And the lock base includes a housing seat, a movable member, plural number discs, plural shaft members, and a fastening device and a pry-proof apparatus, wherein the housing seat accommodates a housing trough and a fastening slot, and the movable member and the number discs are accommodated in the housing trough. The bottom of the movable member is provided with at least one resilient member, where each end of the resilient member abuts elastically against the movable member and the wall of the housing trough respectively, with which the movable member is elastically held by the resilient member. And the movable member has plural openings on it, where the openings are embedded by the plural number discs, and one end of the movable member forms a top rib. The shaft member is put on by a number disc at its one end and joins fixedly with the number disc so that the shaft member is driven for rotation once the number disc is rotated. And the shaft member has a first outer peripheral portion and a second outer peripheral portion, where the second outer peripheral portion is inserted through the number disc and corresponds to the slot of the lock case. And a first grip pit is formed on the first outer peripheral portion. The number discs and the shaft members are penetrated by a pivot, and both ends of the pivot are fixed to the housing seat. The movable member is provided with plural protruding ribs corresponding to the first grip pit of the first outer peripheral portion. The fastening device is located in the fastening slot which accommodates the housing seat, and the fastening device includes at least a fastening part, where the fastening part stretches longitudinally in the fastening slot. The fastening part changes its position subject to the position variation of the top rib, where the fastening part further locks the lock case and the lock bottom.

To achieve the aforementioned objective and function, the pry-proof apparatus of the present creation shields the combination lock from the probing tool to pry, which achieves the features of this device. Therefore, this creation features practicality and inventiveness, considerably worthy of promotion by the industry, and open to the public.

### BRIEF DESCRIPTION OF THE DRAWINGS

FIG. 1 is a partially three-dimensional exploded diagram of a preferred embodiment of the present creation;

FIG. 2 is a three-dimensional exploded diagram of each element of a preferred embodiment of the present creation;

FIG. 3 is a partially three-dimensional diagram of the structure of a preferred embodiment of the present creation;

FIG. 4 is a three-dimensional enlarged diagram of the shaft member of a preferred embodiment of the present creation;

FIG. 5 is a three-dimensional diagram of the probing tool inserted in the aperture after the assembly of a preferred embodiment of the present creation;

FIG. 6 is a schematic diagram of the status that the probing tool is pressed to prop against the shaft member of the first embodiment of the present creation;

FIG. 7 is another sectional diagram of the status that the probing tool is pressed to prop against the shaft member of the first embodiment of the present creation;

FIG. 8 is a three-dimensional diagram of the shaft member of the second embodiment of the present creation;

FIG. 9 is a sectional diagram that the probing tool is pressed to prop against the shaft member of the second embodiment of the present creation;

FIG. 10 is another sectional diagram that the probing tool is pressed to prop against the shaft member of the second embodiment of the present creation;

FIG. 11 is a partially three-dimensional exploded diagram of the prior art;

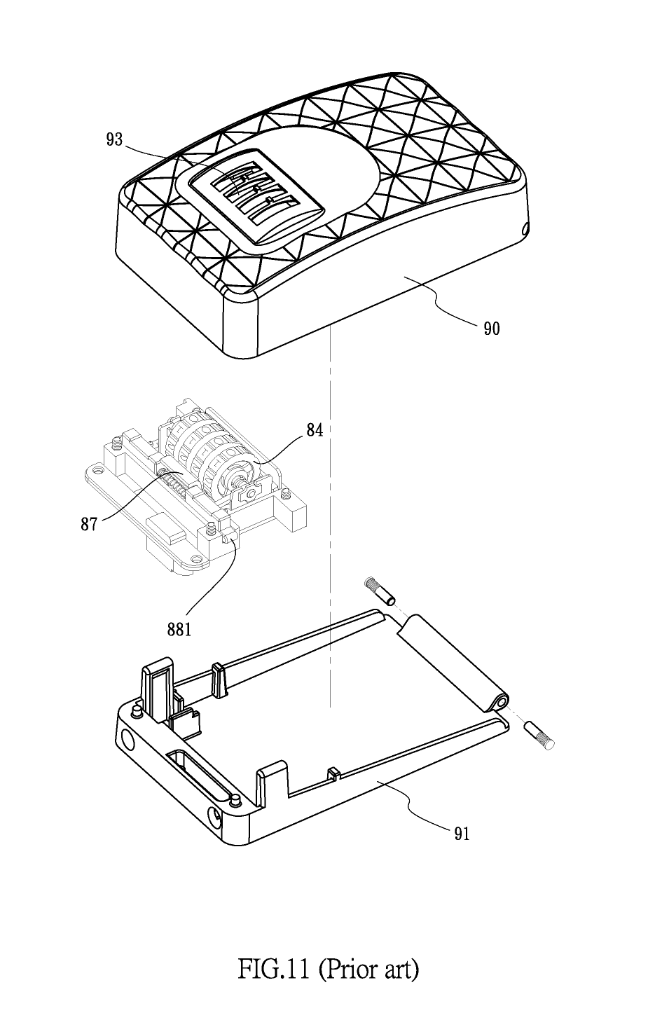

FIG. 12 is a three-dimensional exploded diagram of each element of the prior art;

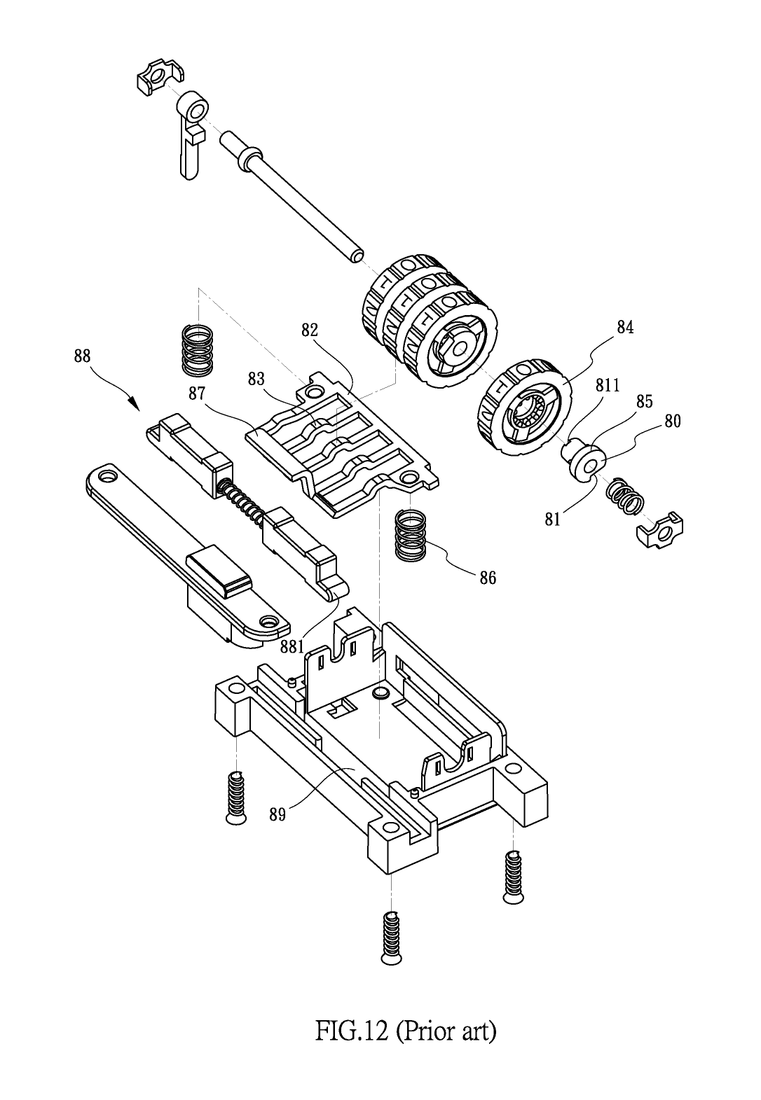

FIG. 13 is a schematic diagram of the status that the probing tool is prying and the grip pit of the shaft member does not abut against the protruding rib of the prior art;

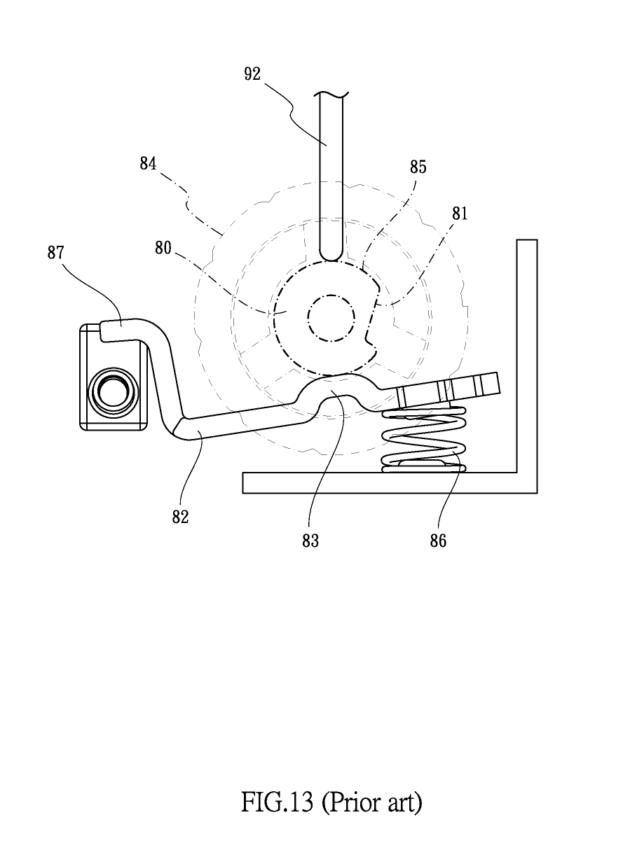

FIG. 14 is a schematic diagram of the status that the probing tool is prying and the grip pit of the shaft member abuts against the protruding rib of the prior art; and

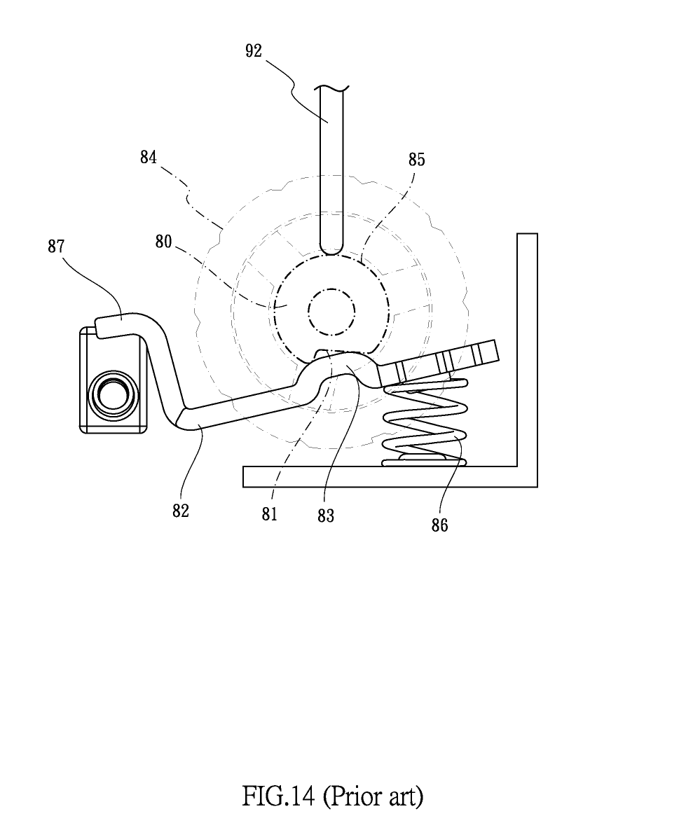

FIG. 15 is a schematic diagram of the status that the probing tool is prying the second grip pit of the shaft member of the prior art.

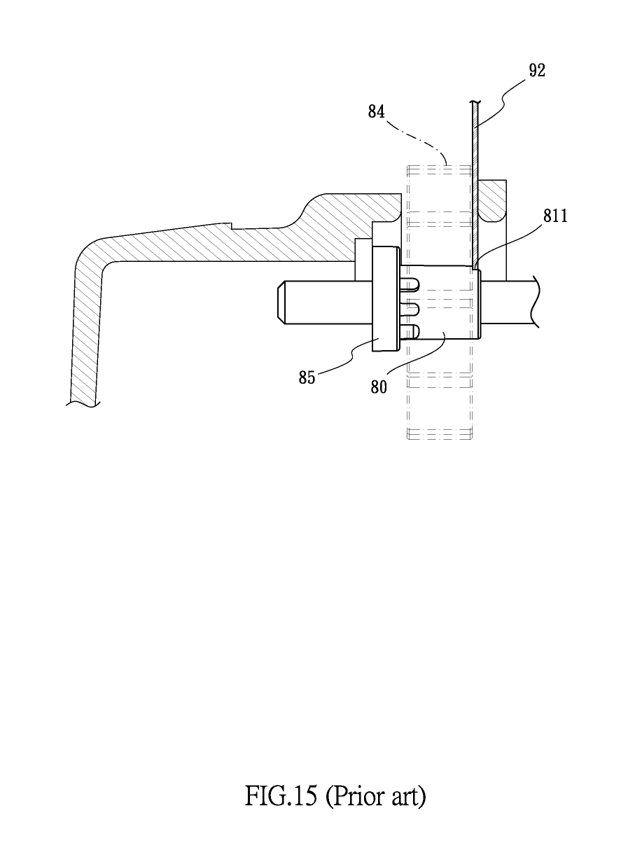

### DETAILED DESCRIPTION OF THE INVENTION

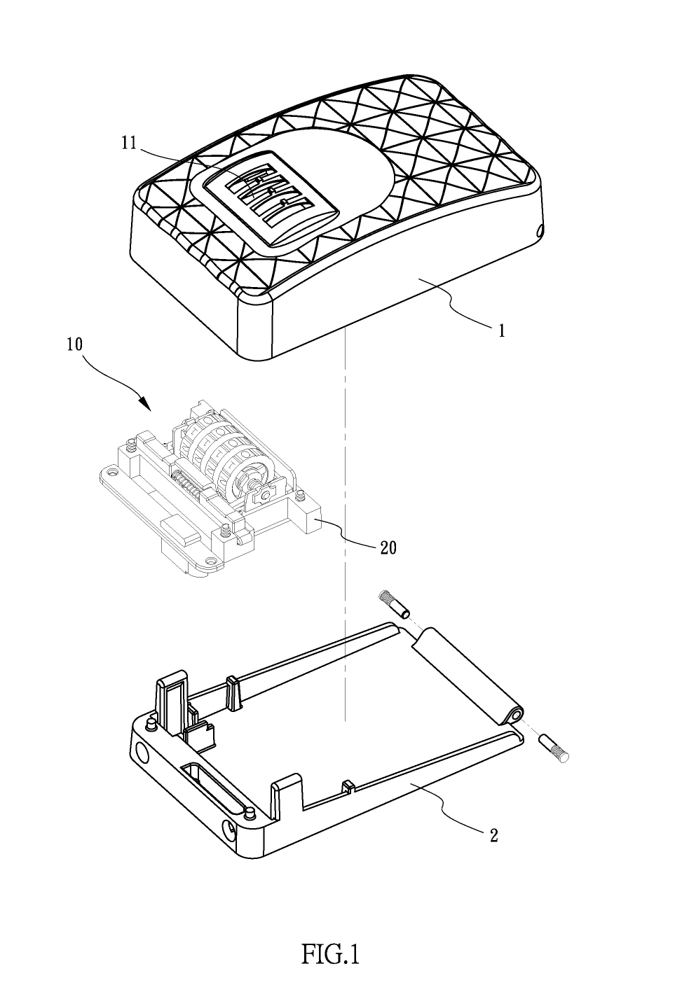

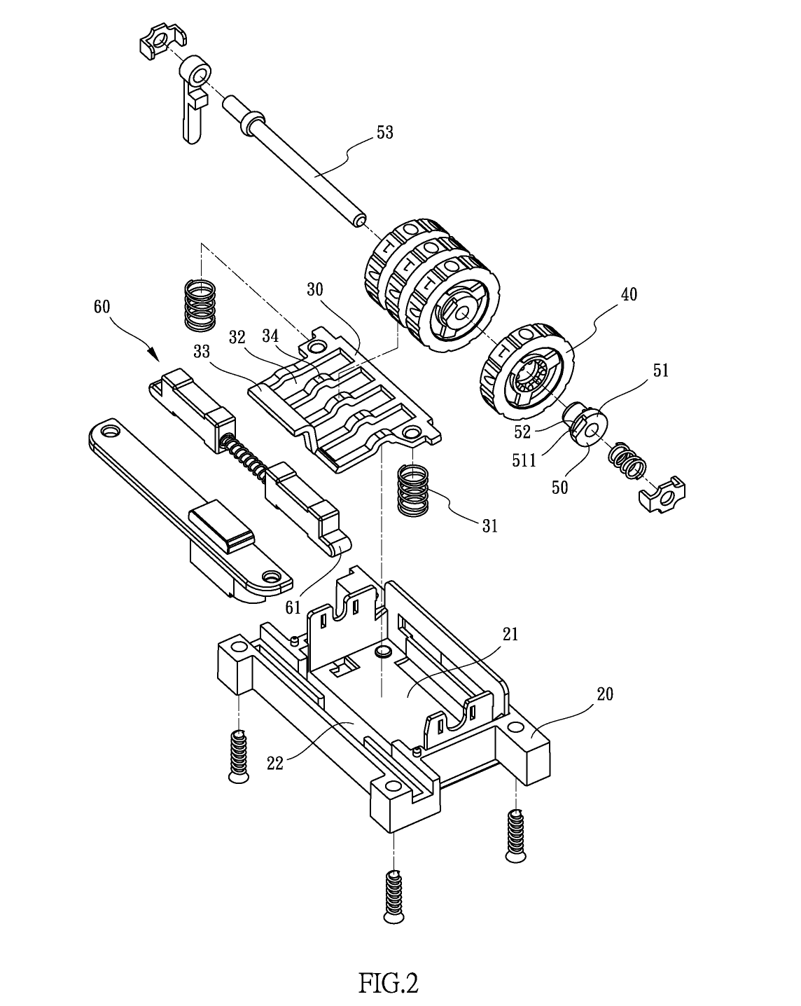

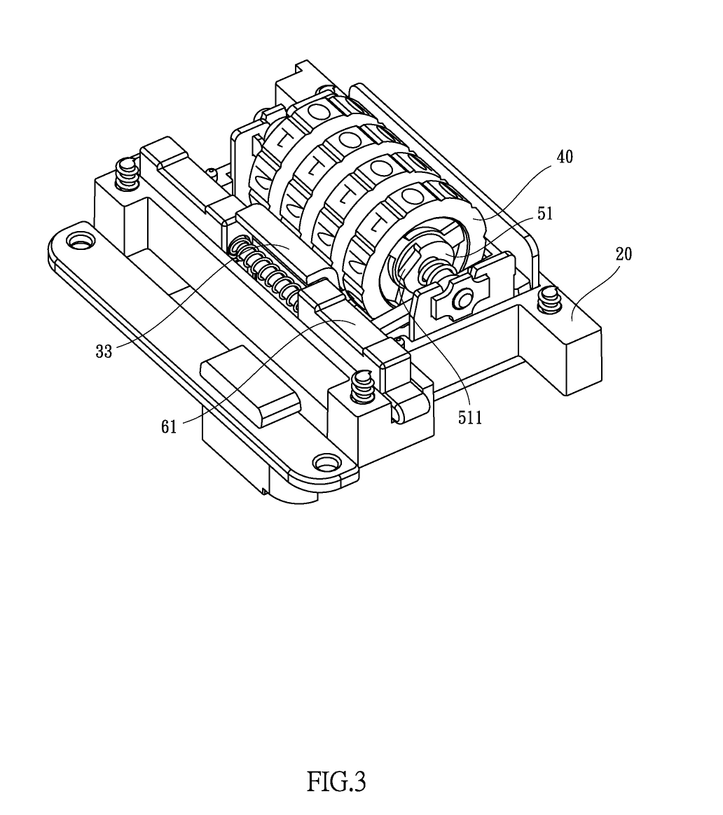

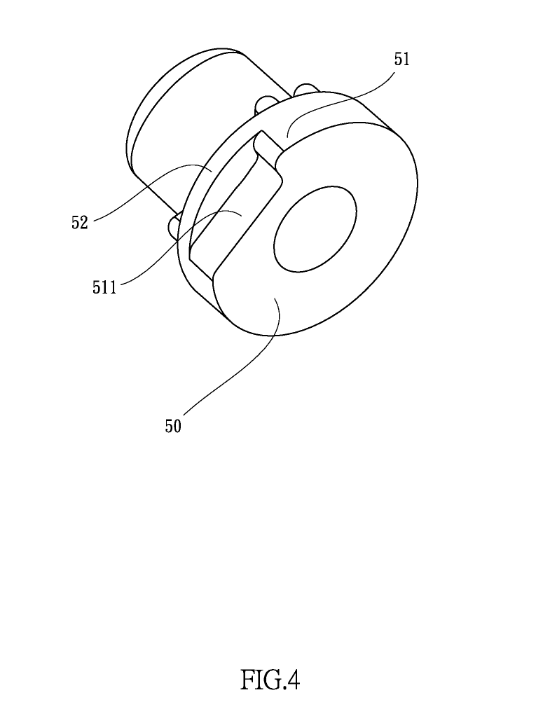

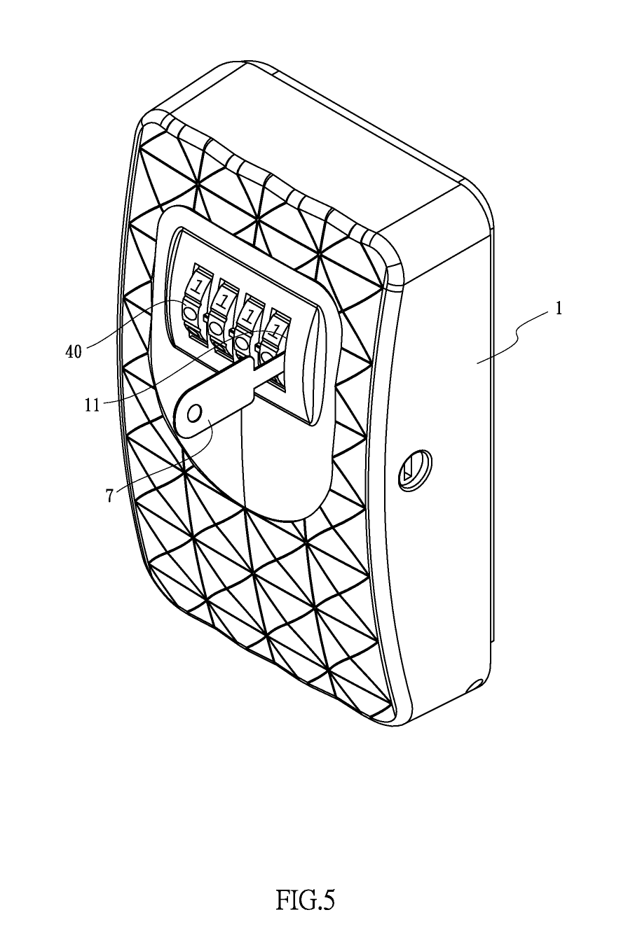

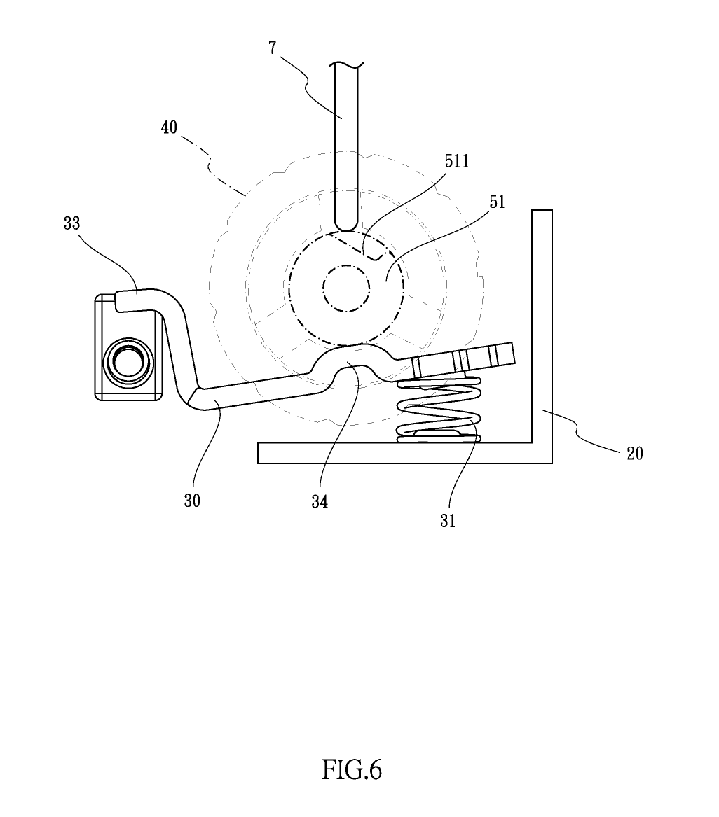

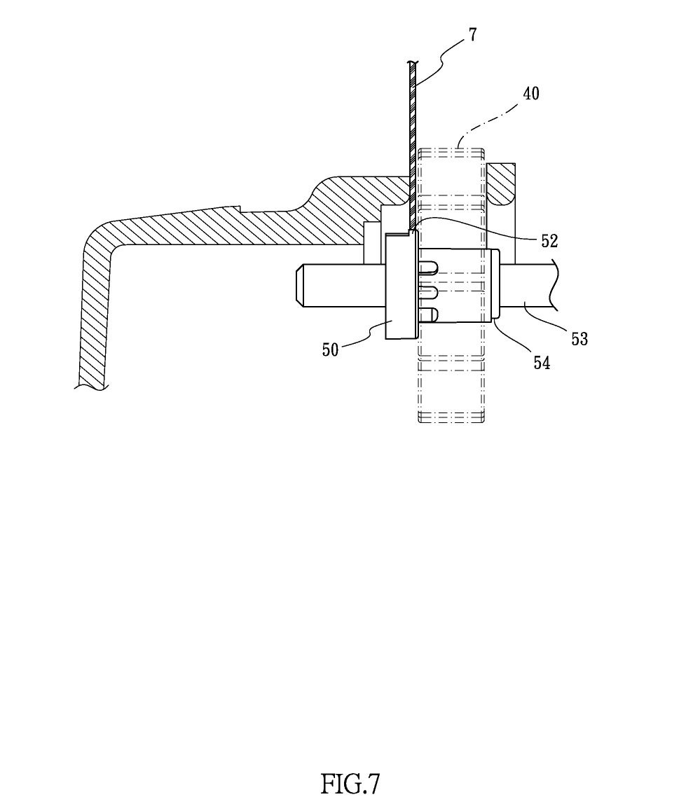

With reference to FIGS. 1-3, an embodiment of the present creation, a pry-proof apparatus of combination locks, comprising: a lock case 1, a lock bottom 2 that can be pivoted on or fixed to the lock case 1, where the lock case 1 is provided with plural apertures 11 on it and a lock base 10 fixed firmly to the lock bottom 2. And the lock base 10 includes a housing seat 20, a movable member 30, plural number discs 40, plural shaft members 50, and a fastening device 60, wherein: the housing seat 20 accommodates a housing trough 21 and a fastening slot 22, and the movable member 30 and the number discs 40 are accommodated in the housing trough 21. The bottom of the movable member 30 is provided with at least one resilient member 31, where each end of the resilient member 31 abuts elastically against the movable member 30 and the wall of the housing trough 21 respectively, with which the movable member 30 is elastically held by the resilient member 31. And the movable member 30 has plural openings 32 on it, where the openings 32 are embedded by the plural number discs 40, and one end of the movable member 30 forms a top rib 33. The shaft member 50 is put on by a number disc 40 at its one end and joins fixedly with the number disc 40 so that the shaft member 50 is driven for rotation once the number disc 40 is rotated. With reference to FIG. 4, the shaft member 50 has a first outer peripheral portion 51 and a second outer peripheral portion 52, where the second outer peripheral portion 52 is inserted in the number disc and corresponds to the aperture 11 of the lock case 1. And a first grip pit 511 is formed on the first outer peripheral portion 51. The number discs 40 and the shaft members 50 are penetrated by a pivot 53 and both ends of the pivot 53 are fixed to the housing seat 20. The movable member 30 is provided with plural protruding ribs 34 corresponding to the first grip pit 511 of the first outer peripheral portion 51. The fastening device 60 is located in the fastening slot 22 which accommodates the housing seat 20, and the fastening device 60 includes at least a fastening part 61, where the fastening part 61 stretches longitudinally in the fastening slot 22, and locks the lock case 1 and the lock bottom 2 (which is the prior structure, no iteration herewith) subject to the position variation of the top rib 33 of the movable member 30. In this way, with reference to FIGS. 5-7, once a pry inserts the tapering plate probing tool 7 into the aperture 11 between the number discs 40 and the aperture 11 of the lock case 1 again, due to the narrowness of the aperture 11, which can only be descended to the second outer peripheral portion 52 of the shaft member 50 that pries for nothing, no matter how the first grip pit 511 is aligned with the protruding rib 34 (the number of dialed number discs 40 is not compliant to the password number) or not (the number of dialed number discs 40 is compliant to the password number), to achieve the features of this device, which substantially avoids pries and prying tools. Therefore, this creation features locking function of original combination locks, simplicity of structure and assembly, and pry-proof which conforms to practicality.

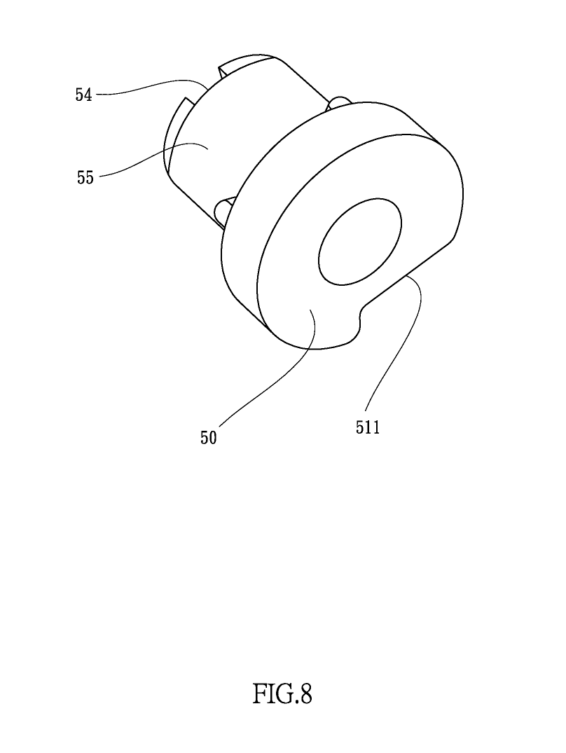

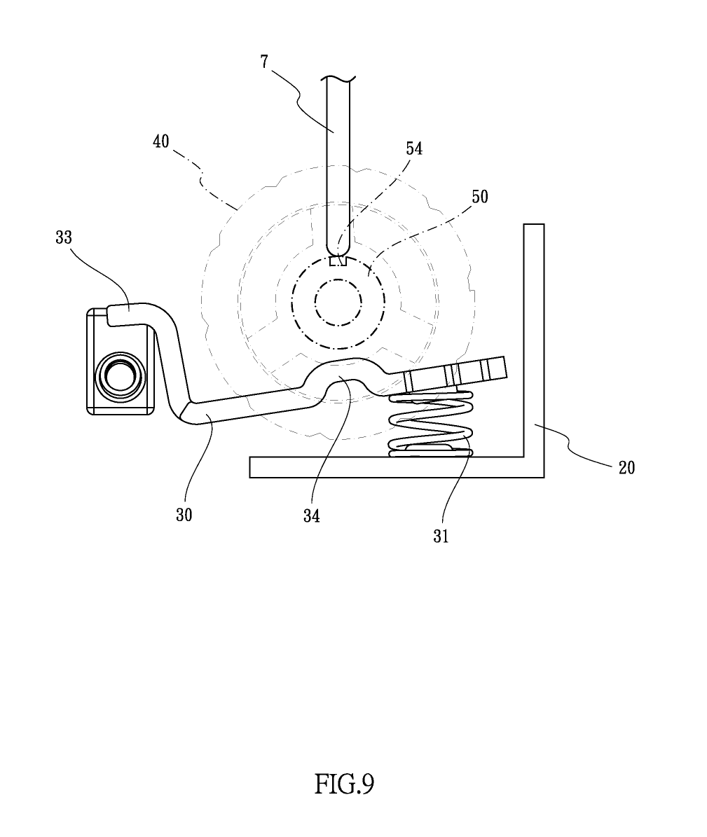

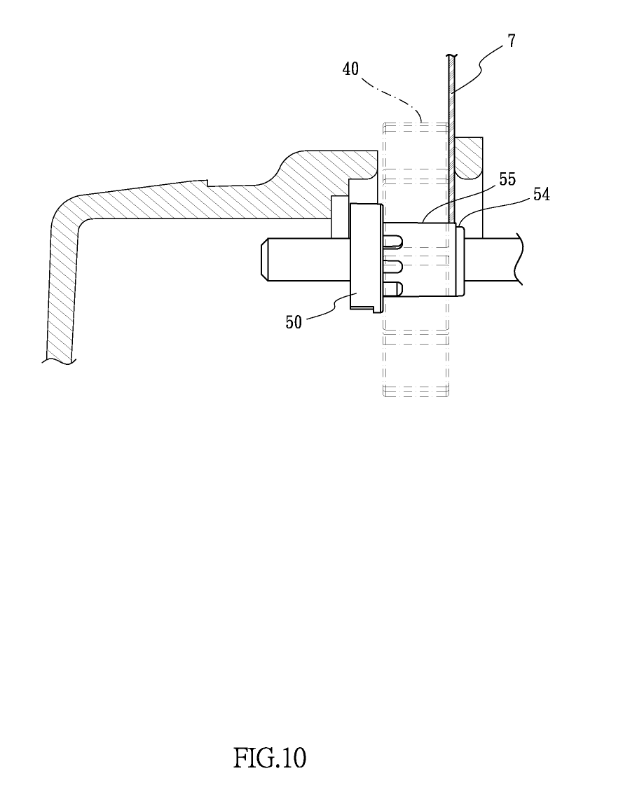

The above description is the first embodiment of this creation. Additionally, for the sake of handy assembly, a second embodiment is provided, shown in FIGS. 8-10. The target of the second embodiment is that a first outer peripheral portion 51, a second outer peripheral portion 52 and a first grip pit 511 are formed at an end of the shaft member 50, whereas a second grip pit 54 and a third outer peripheral portion 55 are formed at the other end of the shaft member 50, and the protruding rib 34 of the movable member 30 corresponds to the second grip pit 54, and the third outer peripheral portion 55 is inserted in the number disc 40 and corresponds to the aperture 11 of the lock case 1 while the rest of the apparatus are kept in the same configuration, with which the probing tool 7, even further with additional pressing, abuts merely against the third outer peripheral portion 55. In other words, no matter how the second grip pit 54 is aligned with the protruding rib 34 (the number of dialed number discs 40 is not compliant to the password number) or not (the number of dialed number discs 40 is compliant to the password number). And the probing tool would pry about nothing, which substantially avoids pries and prying tools. Therefore, this creation features locking function of original combination locks, simplicity of structure and assembly, and pry-proof which conforms to practicality.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the pry-proof apparatus of the combination locks of this creation has not appeared in the prior art and features efficacy better than the prior structure which is construed to be a novel and creative invention, thereby filing the present application herein subject to the patent law.

1. A pry-proof apparatus of combination locks, comprising:
a lock case; and a lock bottom; pivoted on or fixed to said lock case, where said lock case is provided with a plurality of apertures thereon and a lock base fixed firmly to said lock bottom, and the lock base comprising a housing seat, a movable member, a plurality of number discs, a plurality of shaft members, and a fastening device, wherein:
the housing seat is provided with a housing trough and a fastening slot, and the movable member and the number discs are accommodated in the housing trough, a bottom of the movable member is provided with at least a resilient member, where each end of the resilient member abuts elastically against the movable member and a wall of the housing trough respectively, with which the movable member is elastically held by the resilient member, and the movable member has a plurality of openings thereon, where the openings encircle the number discs, and an end of the movable member forms a top rib, and
the shaft member is put on by the number disc at one end thereof and joins fixedly with the number disc so that the shaft member is driven for rotation once the number disc is rotated, and the shaft member forms a first outer peripheral portion and a second outer peripheral portion, where a tubular portion is formed at the other end of the shaft member and the tubular portion is inserted in the number disc and corresponds to the aperture of the lock case and a first grip pit is formed on the first outer peripheral portion, the number discs and the shaft members are penetrated by a pivot, and both ends of the pivot are fixed to the housing seat while the movable member is provided with a plurality of protruding ribs corresponding to the first grip pit of the first outer peripheral portion;
the fastening device is located in the fastening slot which accommodates the housing seat, and the fastening device includes at least a fastening part, where the fastening parts stretch in the fastening slot, and lock said lock case and said lock bottom subject to the position variation of the top rib of the movable member.

2. A pry-proof apparatus of combination locks, comprising:
a lock case; and a lock bottom; pivoted on or fixed to said lock case, where said lock case is provided with a plurality of apertures thereon and a lock base fixed firmly to said lock bottom, where the lock base includes a housing seat, a movable member, a plurality of number discs, a plurality of shaft members, and a fastening device, wherein:
the housing seat accommodates a housing trough and a fastening slot, and the movable member and the number discs are accommodated in the housing trough, a bottom of the movable member is provided with at least a resilient member, where each end of the resilient member abuts elastically against the movable member and a wall of the housing trough respectively, with which the movable member is elastically held by the resilient member, and the movable member has a plurality of openings thereon, where the openings encircle the number discs, and an end of the movable member forms a top rib;
the shaft member is put on by the number disc at one end thereof and joins fixedly with the number disc so that the shaft member is driven for rotation once the number disc is rotated, and the shaft member forms a second grip pit and a third outer peripheral portion, where the third outer peripheral portion is inserted in the number disc and corresponds to the aperture of the lock case, the number discs and the shaft members are penetrated by a pivot, and both ends of the pivot are fixed to the housing seat while the movable member is provided with a plurality of protruding ribs corresponding to the second grip pit of the shaft member, and
the fastening device is located in the fastening slot which accommodates the housing seat, and the fastening device includes at least a fastening part, where the fastening parts stretch in the fastening slot, and lock said lock case and said lock bottom, subject to the position variation of the top rib of the movable member.
